(19) United States
(12) Patent Application Publication
(10) Pub. No.: US 2019/0171679 A1
(43) Pub. Date: Jun. 6, 2019

(54) International Athletic Scouting Combines

(71) Applicant: David Wright, Glen Burnie, MD (US)

(72) Inventor: David Wright, Glen Burnie, MD (US)

(21) Appl. No.: 16/121,573

(22) Filed: Sep. 4, 2018

Related U.S. Application Data
(60) Provisional application No. 62/553,636, filed on Sep. 1, 2017.

(51) Int. Cl. G06F 16/953; G06Q 50/00

(52) U.S. Cl. CPC G06F 16/953; G06Q 50/01

(57) ABSTRACT

A specially designed networking website, through which statistical information regarding high school and collegiate athletes can be stored and accessed by an interactive database that also serves to showcase athletes who may otherwise be overlooked by recruiters.

### CLAIM OF PRIORITY

This patent application claims priority under 35 USC 119 (e)(1) from U.S. Provisional Patent Application Ser. No. 62/553,636 filed Sep. 1, 2017, of common inventorship and title herewith, which is incorporated herein by reference as though the same were set forth in its entirety.

### FIELD OF THE INVENTION

The present invention pertains to the field of computer applications and programs, and more specifically to the field of computer applications and programs allowing professional scouts and coaches a means of selecting players for athletic recruits for further consideration, thus reducing time spent researching and traveling in order to evaluate potential recruits.

### BACKGROUND OF THE INVENTION

For high school athletes, being selected to play one's chosen sport for a college team can mean more than the thrill of participating in a beloved sport at the college level, but can also result in a scholarship that pays for schooling and offers preparation for a career beyond the field or court. While securing an education is a goal of many high school athletes, upon reaching the college level, many other players hope to be scouted for professional play and lucrative professional careers in the NFL, NHL, WNBA or NBA, to name a few. Whether one plays for a high school or college team however, future success often depends on being noticed by professional scouts and coaches who are responsible for selecting players to fill their team rosters. Professional scouts are trained to evaluate the skills and special talents of individual athletes in order to recruit those who will prove worthy contributors to a team's success. During scouting exhibitions, professional scouts might search for raw prospects who may need further development to hone specific skills, while others are more interested in finding talent that is more polished and ready for immediate play. Not surprisingly, the task of evaluating players can be a time consuming process, as a scout might hear through word of mouth or by following local papers that a player is a potential recruit and then research that player's statistics in order to determine if they are a fit for their team. Typically, this involves traveling to watch the athlete in person an expensive endeavor requiring extensive time on the road.

The prior art has put forth several designs for computer applications and programs for this purpose. Among these are:

U.S. Pat. No. 7,769,613 to Pil-Soo Han provides a system and method for estimating the value of athletes using a game achievement evaluation model, wherein objectified quality evaluation is performed including a game situation classified into attack addition, attack subtraction, defense addition and defense subtraction, game factors are defined based on the classified factors, the assignment principle is set, the game factors are subclassified into game situation factors, and the game factors and the game situation factors are given with weights, unlike quantity-based record evaluation by an existing athlete contribution evaluation method. The existing record input method is dependent upon quantitative record only, and thus does not include situation information on how player plays a game under what situation.

US Patent Application No. 2012/0029666 to Michael James Crowley and Kevin King provides a computer-implemented athletic performance analysis method for obtaining, at a computer system, first motion data generated by a test subject moving a test ball containing motion sensors through a predetermined exercise; analyzing in the first motion data, with the computer system, the data from the inertial sensors; and providing to a remote computer at a location of the subject a report regarding the first motion data, the report reflecting a comparison of the first motion data with corresponding motion data of other users who have performed the predetermined exercise.

US Patent Application No. 2005/0183114 to John Lupoi et al provides an athlete recruiting architecture allowing a recruiting entity, such as a school, to search for and find athletes that satisfy recruiting entity-specified criteria. The athlete recruiting system also allows motion videos to be associated with athletes. These motion videos may be uploaded or streamed to interested recruiting entities over a communication network. The athlete recruiting system provides a video indexing mechanism that allows athletes and recruiting entities to generate and store indices to motion videos. The athlete recruiting system provides hit tracking mechanisms for notifying athletes about recruiting entities that have taken actions that indicate that the recruiting entities are interested in the athlete. As a result, athletes are encouraged to initiate contact with interested recruiting entities. This promotes the formation of relationships between athletes and recruiting entities while adhering to rules imposed on the recruiting process.

None of these prior art references describe the present invention.

### SUMMARY OF THE INVENTION

It is an object of the present invention is to provide a computer application or program allowing professional scouts and coaches a means of selecting players for athletic recruits for further consideration to play a sport, thus reducing time spent researching and traveling in order to evaluate potential recruits.

### BRIEF DESCRIPTION OF THE DRAWINGS

FIG. 1 is a front view illustrating a portable tablet showing a screen shot for a web home page for International Athletic Scouting Combines computer program, displayed on a portable device, constructed in accordance with the present invention.

FIG. 2 is a front view illustrating a smart phone showing a screen shot for a web page for International Athletic Scouting Combines computer program, constructed in accordance with the present invention.

FIG. 3 is a front view illustrating a screen shot for a page for International Athletic Scouting Combines computer program, constructed in accordance with the present invention, showing selection of the sport.

FIG. 4 is a front view illustrating a screen shot for a page for International Athletic Scouting Combines computer program, constructed in accordance with the present invention, showing selection of the player by name.

FIG. 5 is a front view illustrating a screen shot of the International Athletic Scouting Combines computer program showing the statistics for a particular player.

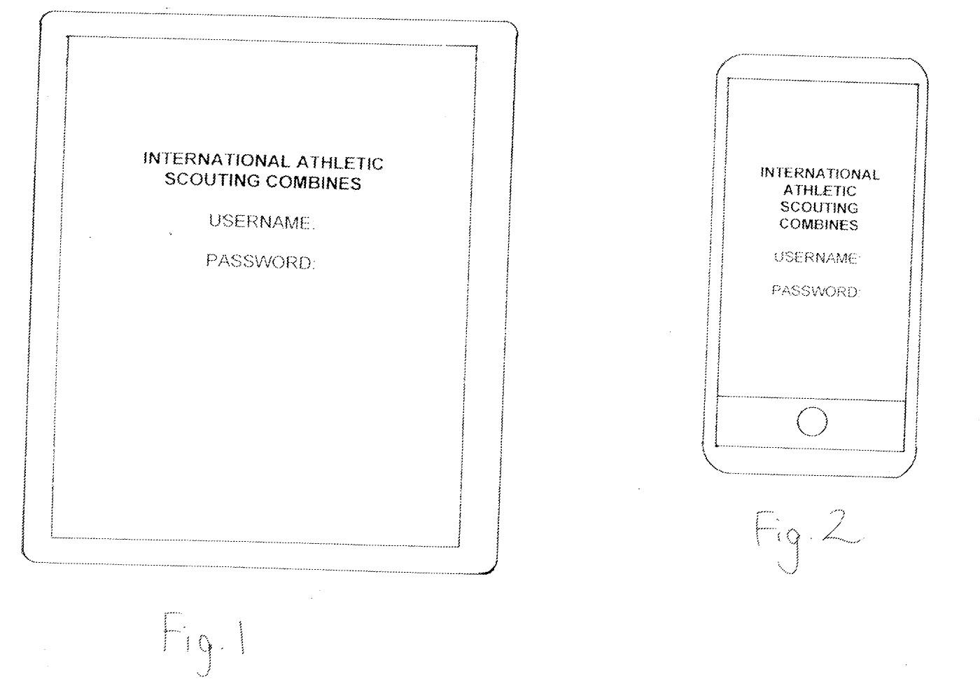

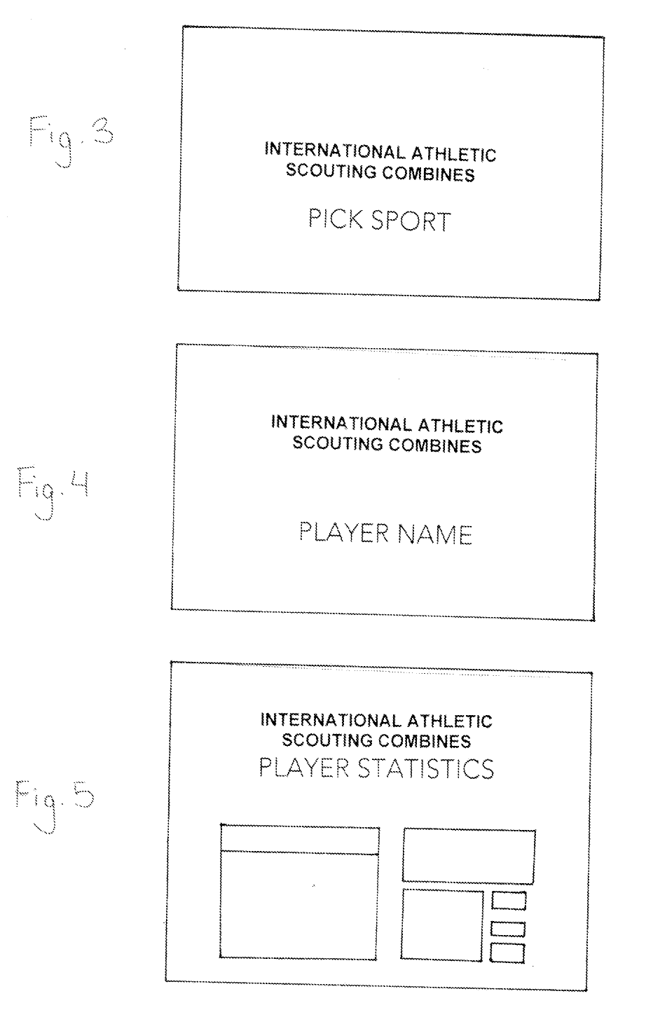

### DETAILED DESCRIPTION OF THE INVENTION

The present invention is an International Athletic Scouting Combines providing a specially designed networking website, through which statistical information regarding high school and collegiate athletes can be stored and accessed. An interactive database that also serves to showcase athletes who may otherwise be overlooked by recruiters, the International Athletic Scouting Combines can be built like standard hierarchical web sites and features a main database, (or home page), as well as tables, text windows, outlines, scripts, and various types of data.

Windows, links, and application icons offered on the International Athletic Scouting Combines website can be organized in accordance to specific sports, as well as by various positions of play. For instance, a window dedicated to high school baseball can be organized in accordance to basemen, pitchers, catchers, hitters, and the like. Detailed specifics spanning a player's career can be included and regularly updated by that player's coach or team administrator. Information can also be included pertaining to player's ranking, division, height, weight, academic performance and other pertinent data.

The International Athletic Scouting Combines encompasses a broad range of sports played by male and female athletes, including high school and college players. The International Athletic Scouting Combines include information pertaining to players of football, baseball, basketball, wrestling, hockey, lacrosse, soccer, swimming, tennis, golf, rugby, jai alai, track and field, polo, water polo, ping pong, diving, snow skiing, water skiing, sailing, volleyball, softball, racquetball, squash and bowling.

The International Athletic Scouting Combines offer links to individual schools and team pages, allowing the scout to further explore detailed information regarding specific players or teams. Importantly, this database features a Search bar that enables the scout to input specific criteria and skills they are searching for in a potential recruit, with the program then running an internal search of its database and providing a list of athletes that meet the parameters of the user's search. A scout can also search the database by inputting a player's name. Searching criteria include: school, year of graduation, sport played, position played, ranking, number or percentage of specific achievements. These achievements can be any achievements usually recorded by a team's or other statistician such as touchdowns, field goals, sacks, interceptions, yards, homeruns outs, strikes, goals, assists, points, etc.

With the designated athlete(s) located in the search, a comprehensive spread sheet is then made available that details personal information and statistics of the player, as well as provide a photograph of the athlete. The International Athletic Scouting Combines is also programmed to accept and display videos of the athlete in action on the field of play. This interactive website contains a database which can be regularly updated by controlled access by coaches in order to ensure that their best athletes are promoted and noticed by scouts, regardless of whether they play for a Division 1 team or are a standout on a Division 3 roster. Further, as the name implies, the International Athletic Scouting Combines is an international website, thus showcasing athletes from around the globe.

The International Athletic Scouting Combine program is capable of searching according to one or more of the following criteria alone or in combination: school, year of graduation, sport played, position played, number or percentage of specific achievements such as touchdowns, field goals, sacks, interceptions, homeruns, outs, strikes, goals, assists, points, etc.

Users of the International Athletic Scouting Combines are charged a nominal fee for accessing and utilizing this service. For practical purposes, this service can be offered on a subscription basis that affords unlimited access for a period of time for a fee. The International Athletic Scouting Combines includes application software for use with any smartphone or tablet computer, thus enabling users to easily access the database on the go.

The International Athletic Scouting Combines is a unique and exciting website concept which offers a number of significant benefits and advantages. Foremost, this innovative site provides athletic scouts a simple and efficient means of locating and selecting potential recruits to fill their team or sporting rosters. A comprehensive, interactive database of high school and collegiate athletes that features statistical information and other pertinent data relating to the individuals profiled on the site, the International Athletic Scouting Combines enables scouts to search specific criteria and determine the best potential recruits for their team. A sophisticated system which organizes athletes by sport, position, age and skill set, the International Athletic Scouting Combines enables scouts to find athletes across the United States and throughout the world that are most suitable for their organization. As such, the International Athletic Scouting Combines provides a sensible alternative to the tedious task of reading scouting reports and sports pages, as well as the arduous process of traveling from school to school in order to find potential recruits. With the International Athletic Scouting Combines, an athlete's entire sports history are available and at one's fingertips.

The International Athletic Scouting Combines also proves advantageous to athletes themselves. Simply stated, by being featured in the International Athletic Scouting Combines, those athletes from smaller schools, rural areas or even regions outside the United States is recognized by scouts and perhaps selected to try out for teams. Allowing dedicated athletes with drive and a competitive spirit to showcase their skills, the International Athletic Scouting Combines provides sporting opportunities to those individuals that may otherwise be overlooked. Further, sports writers and even diehard sports fans might employ this website as a practical means of keeping abreast of up and coming athletes and sporting news, thus the market arena for this site is quite sizable. Easily accessed, this practical site could be reached from any personal computer or laptop, while “app” software can be utilized via a smartphone or tablet computer, enabling the scout to interact with this service at home or on the go.

The International Athletic Scouting Combines is a unique website which provides professional scouts a practical way of building winning teams. Providing instant access to an international database of athletes, this searchable website readily facilitates the scouting process. Easily accessed and affordably priced, the International Athletic Scouting Combines will be well received by professional scouts and coaches, an extremely sizable market potential.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A computer application or program allowing professional scouts and coaches a means of selecting athletic recruit, wherein the recruit is capable of playing a sport, comprising: a networking website, through which a database containing statistical information regarding high school and collegiate athletes can be stored and accessed.

2. The computer application or program of claim 1, wherein the application or program is accessed through a website and includes a database of player information.

3. The computer application or program of claim 2, wherein the sport is selected from the group consisting of football, baseball, basketball, wrestling, hockey, lacrosse, soccer, swimming, tennis, golf, rugby, jai alai, track and field, polo, water polo, ping pang, diving, snow skiing, water skiing, sailing, volleyball, softball, racquetball, squash and bowling.

4. The computer application or program of claim 2, wherein the program is capable of searching according to one or more particular ctriteria.

5. The computer application or program of claim 4, wherein the criteria of the following criteria alone or in combination: name of player, school, year of graduation, sport played, position played, ranking, number or percentage of specific achievements.

6. The computer application or program of claim 5, wherein the specific achievements are selected from the group consisting of touchdowns, field goals, sacks, interceptions, yards, homeruns, outs, strikes, goals, assists, and points.

7. The computer application or program of claim 2, wherein the database is accessed by controlled access.

8. The computer application or program of claim 7, wherein the database includes player information including name, division, height, weight, and academic performance.

9. The computer application or program of claim 2, wherein the web page provides links to individual schools and team pages.

10. The computer application or program of claim 2, wherein the web page includes a photograph of the athlete.

11. The computer application or program of claim 2, wherein the web page includes a video clip of the athlete in action on the field of play.

12. The computer application or program of claim 2, wherein the program is suitable for use with a smartphone or tablet computer.
